(19) United States
(12) Patent Application Publication
(10) Pub. No.: US 2025/0368482 A1
(43) Pub. Date: Dec. 4, 2025

(54) UTILIZING A PLURALITY OF POSITION SYSTEMS TO DETERMINE THE POSITION OF MATERIALS HANDLING VEHICLES WITHIN A COVERED ENVIRONMENT

(71) Applicant: Crown Equipment Corporation, New Bremen, OH (US)

(72) Inventors: Benjamin Morelli, Aukland (NZ); Ryan Estep, Aukland (NZ); Dustin Seger, Sharonville, OH (US); Dave Seger, Versailles, OH (US); Mike Corbett, Macedonia, OH (US); Mark Addison, Ludlow Falls, OH (US); Gary Wolters, Coldwater, OH (US); Jamison Frady, Ansonia, OH (US); Matt Niekamp, Celina, OH (US)

(73) Assignee: Crown Equipment Corporation, New Bremen, OH (US)

(21) Appl. No.: 19/217,192

(22) Filed: May 23, 2025

Related U.S. Application Data
(60) Provisional application No. 63/654,866, filed on May 31, 2024.

(51) Int. Cl. B66F 9/075; B66F 9/06; G05D 1/247; G05D 105/28; G05D 107/70; G05D 111/30

(52) U.S. Cl. CPC B66F 9/0755; B66F 9/063; G05D 1/247; G05D 2105/28; G05D 2107/70; G05D 2111/32

(57) ABSTRACT

Embodiments provided herein include systems and methods for determining a position of a vehicle in a covered environment. The method may include monitoring the position of the vehicle in a free range area of the covered environment using a first data weighting that primarily favors data received from the plurality of transceiver anchors, and determining the position of the materials handling vehicle via a second data weighting. The second data weighting may include determining a first dimension of the position of the materials handling vehicle based primarily on data generated by the one or more vehicle sensors, receiving data from a subset of transceiver anchors of the plurality of transceiver anchors, and determining a second dimension of the position of the materials handling vehicle primarily based on the received data via the vehicle transceiver.

### CROSS REFERENCE

This application claims the benefit of U.S. Provisional Application Ser. No. 63/654,866 filed on May 31, 2024, which is hereby incorporated by reference in its entirety.

### BACKGROUND

For industrial vehicles, such as materials handling vehicles that operate in covered environments, such as warehouses, retail establishments, manufacturing environments, etc., it is advantageous to track the position of the vehicle. In some instances, tracking the position of the vehicle may be used by a central system to monitor the workflow of a fleet of vehicles, or may be used by individual vehicles to be automatically controlled within the covered environment. Vehicle position determination systems may struggle to correctly determine the position of the vehicle when the vehicle is in a confined area, such as in an aisle formed between multi-level racking systems, as signals may be interfered with or distorted.

Current solutions may utilize transceiver anchors to determine the position of materials handling vehicles within a covered environment. While these current solutions may operate normally while the materials handling vehicle is transiting within a free range area of the covered environment that has line of sight to multiple transceiver anchors, these current solutions may not accurately determine the position of the materials handling vehicle when the vehicle is within aisles formed between multi-level racking systems because of interference and/or limited coverage areas. As such, a need in the industry exists for improved systems and methods for determining the position of materials handling vehicles within a covered environment.

### SUMMARY

A first aspect includes a system comprising: a materials handling vehicle that includes a vehicle transceiver for receiving a communication from a plurality of transceiver anchors that are placed on respective stationary objects within a covered environment and a vehicle sensor for detecting at least one of a plurality of guidewires, each of the plurality of guidewires placed between a plurality of dividers; a computing device associated with the materials handling vehicle that includes a processor and a memory component, the memory component storing vehicle position logic that, when executed by the processor, causes the system to perform the following: determine a recent location of the materials handling vehicle from data received from at least a portion of the plurality of transceiver anchors; determine a proximity of the materials handling vehicle to a proximate guidewire of the plurality of guidewires; engage with the proximate guidewire; determine a first dimension of a position of the materials handling vehicle based on a known location of the proximate guidewire; receive, via the vehicle transceiver, data from a first transceiver anchor and second transceiver anchor of the plurality of transceiver anchors; determine a second dimension of the position of the materials handling vehicle based on the received data from the first transceiver anchor and the second transceiver anchor; determine the position of the materials handling vehicle in the covered environment from the first dimension and the second dimension; and alter operation of the materials handling vehicle, based on the position.

A second aspect includes the first aspect, wherein the second dimension is determined from a time of flight differential between communication with the first transceiver anchor and communication with the second transceiver anchor.

A third aspect includes the first aspect and/or the second aspect, wherein the vehicle sensor comprises at least one of a gyroscope, an accelerometer, a steering wheel sensor, a magnet, an inertial measurement unit (IMU), a radio frequency identifier (RFID), or a wheel speed sensor.

A fourth aspect includes any of the first aspect through the third aspect, wherein the materials handling vehicle includes an option to alter a weighting of using the vehicle transceiver to determine the first dimension.

A fifth aspect includes any of the first aspect through the fourth aspect, wherein the logic further causes the system to determine that only a subset of the plurality of transceiver anchors have line of sight to the materials handling vehicle due to an obstruction from at least one of the plurality of dividers, and wherein a weighting of using the vehicle transceiver to determine the first dimension is automatically changed in response to determining that only the subset of the plurality of transceiver anchors have line of sight to the materials handling vehicle.

A sixth aspect includes any of the first aspect through the fifth aspect, wherein a weighting of using the vehicle transceiver to determine the first dimension is automatically changed in response to determining that the materials handling vehicle is within a predetermined distance of the proximate guidewire.

A seventh aspect includes any of the first aspect through the sixth aspect, wherein the covered environment includes a restriction zone positioned at a throat of an aisle defined by the plurality of dividers and wherein a weighting of using the vehicle transceiver to determine the first dimension is automatically changed in response to determining that the materials handling vehicle enters the restriction zone.

An eighth aspect any of the first aspect through the seventh aspect, wherein altering operation of the materials handling vehicle includes at least one of the following: engaging an autonomous mode, engaging a semi-autonomous mode, engaging a manual mode.

A ninth aspect includes a materials handling vehicle comprising: a vehicle transceiver for receiving a first communication from a plurality of transceiver anchors that are placed on respective stationary objects within a covered environment; a vehicle sensor for detecting at least one of a plurality of guidewires, wherein each of the plurality of guidewires is placed between a plurality of dividers; and a computing device that includes a processor and a memory component, the memory component storing vehicle position logic that, when executed by the processor, causes the materials handling vehicle to perform the following: determine a recent location of the materials handling vehicle from data received from at least a portion of the plurality of transceiver anchors; determine a proximity of the materials handling vehicle to a proximate guidewire of the plurality of guidewires; engage with the proximate guidewire; determine a first dimension of a position of the materials handling vehicle based on a known location of the proximate guidewire; receive, via the vehicle transceiver, data from a first transceiver anchor and second transceiver anchor of the plurality of transceiver anchors; determine a second dimension of the position of the materials handling vehicle based on the received data from the first transceiver anchor and the second transceiver anchor; determine the position of the materials handling vehicle in the covered environment from the first dimension and the second dimension; and alter operation of the materials handling vehicle, based on the position.

A tenth aspect includes the ninth aspect, wherein the second dimension is determined from a time of flight differential between communication with the first transceiver anchor and communication with the second transceiver anchor.

An eleventh aspect includes the ninth and/or the tenth aspect, further comprising an option to alter a weighting of using the vehicle transceiver to determine the first dimension.

A twelfth aspect includes any of the ninth aspect through the eleventh aspect, wherein the logic further causes the materials handling vehicle to determine that only a subset of the plurality of transceiver anchors have line of sight to the materials handling vehicle due to an obstruction from at least one of the plurality of dividers, and wherein a weighting of using the vehicle transceiver to determine the first dimension is automatically changed in response to determining that only the subset of the plurality of transceiver anchors have line of sight to the materials handling vehicle.

A thirteenth aspect includes any of the ninth aspect through the twelfth aspect, wherein a weighting of using the vehicle transceiver to determine the first dimension is automatically changed in response to determining that the materials handling vehicle is within a predetermined distance of the proximate guidewire.

A fourteenth aspect includes any of the ninth aspect through the thirteenth aspect, wherein the covered environment includes a restriction zone positioned at a throat of an aisle defined by the plurality of dividers and wherein a weighting of using the vehicle transceiver to determine the first dimension is automatically changed in response to determining that the materials handling vehicle enters the restriction zone.

A fifteenth aspect includes any of the ninth aspect through the fourteenth aspect, wherein altering operation of the materials handling vehicle includes at least one of the following: engaging an autonomous mode, engaging a semi-autonomous mode, or engaging a manual mode.

A sixteenth aspect includes a method comprising: determining, by a computing device, a recent location of a materials handling vehicle from data received from at least a portion of a plurality of transceiver anchors, wherein the materials handling vehicle includes a vehicle transceiver for communicating with the plurality of transceiver anchors; determining, by the computing device, a proximity of the materials handling vehicle to a proximate guidewire of a plurality of guidewires located in a covered environment, wherein the covered environment further includes the plurality of transceiver anchors and a plurality of dividers; engaging, by the computing device, with the proximate guidewire; determining, by the computing device, a first dimension of a position of the materials handling vehicle based on a known location of a proximate guidewire of the plurality of guidewires; receiving, via the vehicle transceiver, data from a first transceiver anchor and second transceiver anchor of the plurality of transceiver anchors; determining, by the computing device, a second dimension of the position of the materials handling vehicle based on the received data from the first transceiver anchor and the second transceiver anchor; determining, by the computing device, the position of the materials handling vehicle in the covered environment from the first dimension and the second dimension; and altering, by the computing device, operation of the materials handling vehicle, based on the position.

A seventeenth aspect includes the sixteenth aspect, further comprising providing an option to alter a weighting of using the vehicle transceiver to determine the first dimension.

An eighteenth aspect includes the sixteenth aspect and/or the seventeenth aspect, further comprising determining that only a subset of the plurality of transceiver anchors have line of sight to the materials handling vehicle due to an obstruction from at least one of the plurality of dividers, and wherein a weighting of using the vehicle transceiver to determine the first dimension is automatically changed in response to determining that only the subset of the plurality of transceiver anchors have line of sight to the materials handling vehicle.

A nineteenth aspect includes any of the sixteenth aspect through the eighteenth aspect, wherein a weighting of using the vehicle transceiver to determine the first dimension is automatically changed in response to determining that the materials handling vehicle is within a predetermined distance of the proximate guidewire.

A twentieth aspect includes any of the sixteenth aspect through the nineteenth aspect, wherein the covered environment includes a restriction zone positioned at a throat of an aisle defined by the plurality of dividers and wherein a weighting of using the vehicle transceiver to determine the first dimension is automatically changed in response to determining that the materials handling vehicle enters the restriction zone.

A twenty-first aspect includes a materials handling vehicle for traversing a covered environment, the covered environment including a plurality of aisles defined by a multi-racking system and a free range area, comprising: a first position system that includes a vehicle transceiver for receiving a communication from a plurality of transceiver anchors that are placed on respective stationary objects within the covered environment; a second position system that utilizes at least one vehicle sensor to detect objects in the vicinity of the materials handling vehicle; and remotely located computing device that includes a processor and a memory component, the memory component storing logic that, when executed by the processor, causes the materials handling vehicle to perform the following: determine a position of the materials handling vehicle in the free range area, wherein the position includes a first dimension and a second dimension, wherein the position is determined via the first position system communicating with at least a portion of the plurality of transceiver anchors while the materials handling vehicle is located in the free range area; determine that the materials handling vehicle is entering an aisle of the plurality of aisles; and in response to determining that the materials handling vehicle is entering the aisle, automatically and without user interaction, utilize the first position system to determine the first dimension of the position using the vehicle transceiver receiving communications from at least one of the plurality of transceiver anchors that is has line of sight to the materials handling vehicle, utilize the second position system to determine the second dimension of the position using the at least one vehicle sensor, and determine the position of the materials handling vehicle from the first dimension and the second dimension.

A twenty-second aspect includes the twenty-first aspect, wherein the second position system includes at least one of the following: a guidewire engagement system for detecting a guidewire or a floor guide rail system.

A twenty-third aspect includes the twenty-first aspect and/or the twenty-second aspect, wherein determining the first dimension using the second position system includes utilizing at least one of the following: a gyroscope, an accelerometer, a steering wheel sensor, a magnet, or a wheel speed sensor.

A twenty-fourth aspect includes any of the twenty-first aspect through the twenty-third aspect, wherein the covered environment includes a transition zone, wherein the transition zone is utilized to trigger the second position system.

A twenty-fifth aspect includes any of the twenty-first aspect through the twenty-fourth aspect, wherein the logic further causes the materials handling vehicle to determine that the materials handling vehicle is leaving the aisle and, in response to determining that the materials handling vehicle is leaving the aisle, automatically disengage the second position system.

A twenty-sixth aspect includes any of the twenty-first aspect through the twenty-fifth aspect, wherein in response to determining that the materials handling vehicle is leaving the aisle, the logic causes the materials handling vehicle to utilize automatically the first position system to monitor the first dimension and the second dimension of the position of the materials handling vehicle in the covered environment.

A twenty-seventh aspect includes any of the twenty-first aspect through the twenty-sixth aspect, wherein the logic further causes the materials handling vehicle to generate an alert for at least one of the following: when the materials handling vehicle enters the aisle or if the materials handling vehicle has not properly engaged with a wire guidance system.

A twenty-eighth aspect includes any of the twenty-first aspect through the twenty-seventh aspect, wherein the logic further causes the materials handling vehicle to automatically reduce a speed restriction on the materials handling vehicle when the materials handling vehicle enters the aisle.

A twenty-ninth aspect includes a system comprising a materials handling vehicle that includes a guidewire engagement system for engaging with a guidewire, a first position system that includes a vehicle transceiver for receiving a communication from a plurality of transceiver anchors that are placed on respective stationary objects within a covered environment and determining a position of the materials handling vehicle in a free range area of the covered environment, and a second position system that utilizes a vehicle sensor and the vehicle transceiver for determining the position of the materials handling vehicle in an aisle of the covered environment; and a remotely located computing device that includes a processor and a memory component, the memory component storing logic that, when executed by the processor, causes the system to perform the following: determine the position of the materials handling vehicle in the free range area, wherein the position is determined via the first position system communicating with the plurality of transceiver anchors while the materials handling vehicle is located in the free range area; determine that the materials handling vehicle is entering the aisle; in response to determining that the materials handling vehicle is entering the aisle, automatically and without user interaction, utilize the guidewire engagement system to engage with the guidewire and enable the second position system to determine a first dimension of the position using the vehicle sensor and determine a second dimension of the position using the vehicle transceiver receiving communications from a subset of transceiver anchors of the plurality of transceiver anchors; and utilize the second position system to determine the position of the materials handling vehicle from the first dimension and the second dimension.

A thirtieth aspect the twenty-ninth aspect, wherein determining the first dimension using the second position system includes utilizing at least one of the following: a gyroscope, an accelerometer, a steering wheel sensor, a magnet, or a wheel speed sensor.

A thirty-first aspect includes the twenty-ninth aspect and/or thirtieth aspect, wherein, the subset of transceiver anchors have line of sight to the materials handling vehicle when the materials handling vehicle is located in the aisle.

A thirty-second aspect includes any of the twenty-ninth aspect through the thirty-first aspect through the thirty-first aspect, wherein the covered environment includes a transition zone, wherein the transition zone is utilized to trigger the second position system.

A thirty-third aspect includes any of the twenty-ninth aspect through the thirty-second aspect, wherein the logic further causes the system to determine that the materials handling vehicle is leaving the aisle and, in response to determining that the materials handling vehicle is leaving the aisle, the system performs at least one of the following; automatically disengage the second position system or automatically utilize the first position system to monitor the position of the materials handling vehicle in the covered environment.

A thirty-fourth aspect includes any of the twenty-ninth aspect through the thirty-third aspect, wherein the logic further causes the materials handling vehicle to generate an alert when the materials handling vehicle enters the aisle.

A thirty-fifth aspect includes any of the twenty-ninth aspect through the thirty-fourth aspect, wherein the logic further causes the system to automatically slow the materials handling vehicle when the materials handling vehicle enters the aisle.

A thirty-sixth aspect includes a method comprising determining, by a computing device, a position of a materials handling vehicle in a free range area of a covered environment, wherein the position is determined via a first position system of the materials handling vehicle that includes a vehicle transceiver communicating with a plurality of transceiver anchors in the covered environment while the materials handling vehicle is located in the free range area; determining, by the computing device that the materials handling vehicle is entering an aisle in the covered environment; in response to determining that the materials handling vehicle is entering the aisle, automatically engaging a guidewire engagement system to engage with a guidewire in the aisle and enabling, by the computing device, a second position system of the materials handling vehicle to determine a first dimension of the position using a vehicle sensor and determine a second dimension of the position using the vehicle transceiver receiving communications from a subset of transceiver anchors of the plurality of transceiver anchors; and utilizing, by the computing device, the second position system to determine the position of the materials handling vehicle from the first dimension and the second dimension.

A thirty-seventh aspect includes the thirty-sixth aspect, wherein determining the first dimension using the second position system includes utilizing at least one of the following: a gyroscope, an accelerometer, a steering wheel sensor, a magnet, or a wheel speed sensor.

A thirty-eighth aspect includes the thirty-sixth aspect and/or the thirty-seventh aspect, wherein the covered environment includes a transition zone, wherein the transition zone is utilized to trigger the second position system.

A thirty-ninth aspect includes any of the thirty-sixth aspect through the thirty-eighth aspect, further comprising determining that the materials handling vehicle is leaving the aisle and, in response to determining that the materials handling vehicle is leaving the aisle, automatically disengage the second position system.

A fortieth aspect includes any of the thirty-sixth aspect through the thirty-ninth aspect, further comprising automatically slowing the materials handling vehicle when the materials handling vehicle enters the aisle.

A forty-first aspect includes a materials handling vehicle comprising a vehicle transceiver for receiving a communication from a plurality of transceiver anchors that are placed on respective stationary objects within a covered environment and one or more vehicle sensors; a computing device that includes a processor and a memory component, the memory component storing logic that, when executed by the processor, causes the materials handling vehicle to perform the following: determine a first dimension of a position of the materials handling vehicle based on data generated by the one or more vehicle sensors; receive, via the vehicle transceiver, data from a subset of transceiver anchors of the plurality of transceiver anchors; determine a second dimension of the position of the materials handling vehicle based on the received data via the vehicle transceiver; determine the position of the materials handling vehicle from the first dimension and the second dimension; and alter operation of the materials handling vehicle based on the position.

A forty-second aspect includes the forty-first aspect, wherein the one or more vehicle sensors comprises at least one of the following; a gyroscope, an accelerometer, a steering wheel sensor, a magnet, or a wheel speed sensor.

A forty-third aspect includes the forty-first aspect and/or the forty-second aspect, wherein the materials handling vehicle includes at least two different types of vehicle sensors and signals generated by each of the at least two different types of vehicle sensors are weighted into an output interpreted by at least one of the following: the materials handling vehicle or a remotely located computing device.

A forty-fourth aspect includes any of the forty-first aspect through the forty-third aspect, wherein the materials handling vehicle includes a user option to manually alter a weighting of using the vehicle transceiver to determine the first dimension.

A forty-fifth aspect includes any of the forty-first aspect through the forty-fourth aspect, wherein the subset of transceiver anchors are positioned with line of sight to the materials handling vehicle along an aisle, wherein a weighting of using the vehicle transceiver to determine the first dimension is automatically changed in response to determining that only the subset of transceiver anchors have line of sight to the materials handling vehicle when the materials handling vehicle is located at a predetermined position.

A forty-sixth aspect includes any of the forty-first aspect through the forty-fifth aspect, wherein the predetermined position includes at least one of the following: a transition zone or a restriction zone.

A forty-seventh aspect includes any of the forty-first aspect through the forty-sixth aspect, wherein altering operation of the materials handling vehicle includes at least one of the following: changing a speed of the materials handling vehicle, limiting operation of a fork of the materials handling vehicle, or generating an alert to an operator of the materials handling vehicle.

A forty-eighth aspect includes any of the forty-first aspect through the forty-seventh aspect, wherein the vehicle transceiver is an ultra-wide band (UWB) transceiver.

A forty-ninth aspect includes any of the forty-first aspect through the forty-eighth aspect, wherein the logic further causes the materials handling vehicle to determine a proximity of the materials handling vehicle to an aisle.

A fiftieth aspect includes any of the forty-first aspect through the forty-ninth aspect, wherein altering operation of the materials handling vehicle includes at least one of the following: engaging an autonomous mode, engaging a semi-autonomous mode, or engaging a manual mode.

A fifty-first aspect includes a system comprising: a materials handling vehicle that includes a vehicle transceiver for receiving a communication from a plurality of transceiver anchors that are placed on respective stationary objects within a covered environment and one or more vehicle sensors; and a remotely located computing device in communication with the materials handling vehicle that includes a processor and a memory component, the memory component storing logic that, when executed by the processor, causes the system to perform the following: determine a first dimension of a position of the materials handling vehicle based on data generated by the one or more vehicle sensors; receive, via the vehicle transceiver, data from a subset of transceiver anchors of the plurality of transceiver anchors; determine a second dimension of the position of the materials handling vehicle based on the received data from a via the vehicle transceiver; determine the position of the materials handling vehicle from the first dimension and the second dimension; and alter operation of the materials handling vehicle, based on the position.

A fifty-second aspect includes the fifty-first aspect, wherein the one or more vehicle sensors comprises at least one of the following: a gyroscope, an accelerometer, a steering wheel sensor, a wire guidance device, or a wheel speed sensor.

A fifty-third aspect includes the fifty-first aspect and/or the fifty-second aspect, wherein the materials handling vehicle includes at least two different types of vehicle sensors and signals generated by each of the at least two different types of vehicle sensors are weighted into an output interpreted by the materials handling vehicle.

A fifty-fourth aspect includes any of the fifth-first aspect through the fifty-third aspect, wherein the materials handling vehicle includes a user option to manually alter a weighting of using the vehicle transceiver to determine the first dimension.

A fifty-fifth aspect includes any of the fifty-first aspect through the fifty-fourth aspect, wherein the subset of transceiver anchors are positioned with line of sight to the materials handling vehicle along an aisle, wherein a weighting of using the vehicle transceiver to determine the first dimension is automatically changed in response to determining that only the subset of transceiver anchors have line of sight to the materials handling vehicle.

A fifty-sixth aspect includes any of the fifty-first aspect through the fifty-fifth aspect, wherein the materials handling vehicle further includes at least one of the following: a wire guidance device for engaging wire guidance in an aisle or a floor guide rail system.

A fifty-seventh aspect includes any of the fifty-first aspect through the fifty-sixth aspect, wherein the vehicle transceiver is an ultra-wide band (UWB) transceiver.

A fifty-eighth aspect includes a method for determining a position of a materials handling vehicle in a covered environment, wherein the materials handling vehicle includes a vehicle transceiver for communicating with a plurality of transceiver anchors in the covered environment, wherein the materials handling vehicle includes one or more vehicle sensors, comprising: monitoring, by a computing device, the position of the materials handling vehicle in a free range area of the covered environment using a first data weighting that primarily favors data received from the plurality of transceiver anchors; determining, by the computing device, the position of the materials handling vehicle via a second data weighting that includes the following: determining, by the computing device, a first dimension of the position of the materials handling vehicle based primarily on data generated by the one or more vehicle sensors; receiving, by the computing device via the vehicle transceiver, data from a subset of transceiver anchors of the plurality of transceiver anchors; determining, by the computing device, a second dimension of the position of the materials handling vehicle primarily based on the received data via the vehicle transceiver; and determining, by the computing device, the position of the materials handling vehicle from the first dimension and the second dimension.

A fifty-ninth aspect includes the fifty-eighth aspect, further comprising providing a user option to manually alter a weighting of using the vehicle transceiver to determine the first dimension.

A sixtieth aspect includes the fifty-eighth aspect and/or the fifty-ninth aspect, wherein the materials handling vehicle further includes at least one of the following: a wire guidance device for engaging wire guidance in an aisle or a floor guide rail system.

Another aspect includes any of the previous aspects, wherein the covered environment is configured as at least one of the following: a warehouse environment, a retail environment, a manufacturing environment.

Another aspect includes any of the previous aspects, wherein the vehicle sensor may be configured to determine at least one of the following: speed or wheel angle, and wherein speed and wheel angle may be sampled at a high rate and used to run a dead reckoning algorithm to estimate the displacement and rotation of the materials handling vehicle.

Another aspect includes any of the previous aspects, wherein the materials handling vehicle includes a sensor for detecting whether the materials handling vehicle is located proximate to at least one of the plurality of guidewires and, in response to determining that the materials handling vehicle is proximate to the at least one guidewire, entering a mode where the materials handling vehicle is actively guided by a guidewire such that vehicle movement is restricted to moving along the guidewire and informing the vehicle computing device that the materials handling vehicle is guidewire locked.

Another aspect includes any of the previous aspects, wherein the materials handling vehicle includes a first LiDAR device mounted on a front of the materials handling vehicle and a second LiDAR device mounted on a rear of the materials handling vehicle.

Another aspect includes any of the previous aspects, wherein the logic includes at least one of the following: an RTLS live map that is configured as a graphical facility map showing icons for real time locations of all active UWB devices, a reporting module that is configured to provide API access to a user to generate its own reports and provide additional data as part of existing reports, and wherein the reporting module includes an API module, a reports module, a heat maps module, a route playback module, an enhancements module that is configured to provide options for users to manage alerts, notifications, equipment, and user data associated with telematics services provided for the materials handling vehicle, a commissioning tools module that includes tools to setup and manage the virtual representation of the facility and zones where the system should exercise control and/or awareness to UWB tags, or vehicle position logic that enables low latency, high accuracy vehicle tracking, vehicle reactions, and operator/user alerts.

Another aspect includes any of the previous aspects, wherein the logic further includes a geolocation engine that is configured to manage UWB communications, including high precision time syncing and location tracking.

Another aspect includes any of the previous aspects, wherein the vehicle transceiver emits a beacon signal that can be uniquely identified to an individual vehicle transceiver that sent the signal.

Another aspect includes any of the previous aspects, further comprising utilizing sensor fusion, which includes passing data to a sensor fusion algorithm, including at least one of the following: a time difference of arrival (TDoA) position of the vehicle transceiver, a quality metric related to accuracy of a TDoA tracked position, timestamps, unique ID, and a quality metric relating to signal reception of each transceiver anchor that received a beacon of the vehicle transceiver, accumulated odometry in an arbitrary coordinate frame at the time of the beacon, an accumulated gyro heading in an arbitrary coordinate frame, or a guidewire locked state.

Another aspect includes any of the previous aspects, further comprising blending data from vehicle sensors with past observations from the vehicle sensors using a recursive state estimation filter.

Another aspect includes any of the previous aspects, further comprising tracking a state of the materials handling vehicle, wherein tracking includes tracking a position of the materials handling vehicle within the covered environment, tracking an orientation or facing direction of the materials handling vehicle within the covered environment, tracking a coordinate offset of accumulated gyroscope data, and track and offset bias and random walk errors of a MEMS gyroscope on the materials handling vehicle.

Another aspect includes any of the previous aspects, further comprising performing UKF prediction, UKF measurement, free range UKF measurement, and in-aisle UKF measurement, wherein UKF prediction includes estimating a UKF state at a time sensor observations are captured.

Another aspect includes any of the previous aspects, further comprising utilizing an in-aisle UKF measurement when TDoA derived position of the vehicle transceiver is not accurate independent of other sensors.

Another aspect includes any of the previous aspects, further comprising performing at least one of the following: non-line-of-sight detection that includes using a predicted pose of a UKF to determine if an obstacle is in between the vehicle transceiver and a transceiver anchor, vehicle shading, which includes using a lift height of the materials handling vehicle to determine if at least one transceiver anchor would have been interfered with by a staging mast or load on the materials handling vehicle, utilizing antenna reception models, which include using non-linear reception characteristics due to the construction of an antenna of the vehicle transceiver and transceiver anchors, determining a quality of signal, or determining a quality of time synchronization.

Another aspect includes any of the previous aspects, further comprising determining a position offset constraint that is formulated as a displacement from the side of the guidewire.

Another aspect includes any of the previous aspects, further comprising determining a heading offset, formulated as a global heading offset from the guidewire.

Another aspect includes any of the previous aspects, wherein altering operation of the materials handling vehicle includes setting a speed limit.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1A depicts an environment-based computing environment for determining a position of a materials handling vehicle within a covered environment, according to embodiments provided herein;

FIG. 1B depicts a cloud-based computing environment for determining a position of a materials handling vehicle within a covered environment, according to embodiments provided herein;

FIG. 2 depicts computing infrastructure associated with the remote computing logic and the vehicle position logic from FIGS. 1A and 1B, according to embodiments provided herein;

FIG. 3 depicts a covered environment with a plurality of guidewires and a materials handling vehicle, according to embodiments provided herein;

FIG. 4 depicts a flowchart of a process for determining a position of a materials handling vehicle, according to embodiments provided herein;

FIG. 5 depicts a flowchart of a process for using sensor fusion to determine a position of a materials handling vehicle, according to embodiments provided herein;

FIG. 6 depicts a flowchart of a process for transitioning a control method of a materials handling vehicle, according to embodiments provided herein; and

FIG. 7 depicts a remote computing device of FIGS. 1A and 1B, according to embodiments provided herein.

### DETAILED DESCRIPTION

Embodiments disclosed herein include systems and methods for determining a position of a materials handling vehicle within a covered environment. Some embodiments utilize embedded guidewires used in conjunction with transceiver anchors. The materials handling vehicle may include a computing device (one or more) that communicates with the guidewires and the transceiver anchors to determine the position of the materials handling vehicle within the covered environment. The computing device associated with the materials handling vehicle, the plurality of guidewires, and the plurality of transceiver anchors may be connected via a network. In some embodiments, a remote computing device may further be connected to the vehicle computing device associated with the materials handling vehicle, the plurality of guidewires, and the plurality of transceiver anchors via the network.

In some embodiments, the materials handling vehicle may contain one or more position sensors. The position sensors may be used in conjunction with the transceiver anchors to determine the position of the materials handling vehicle within the covered environment.

A covered environment may include a warehouse environment, a manufacturing environment, a retail environment, an industrial environment, a distribution environment, a commercial environment, or other area that includes a plurality of anchors and tags, where the location technology is configured to track the location and pose of the tags within a geographical area covered by the anchors. In some embodiments, the covered environment may include one or more multi-level racking systems with aisles formed between the multi-level racking systems. Each of the aisles may have a pair of throats, where each throat is formed at the entry or exit of each aisle. A transition zone may be formed at each of the throats. The transition zones may be virtual areas which the materials handling vehicle may detect when the materials handling vehicle enters. By entering or exiting the transition zone, the materials handling vehicle may automatically change position determining systems and/or control systems.

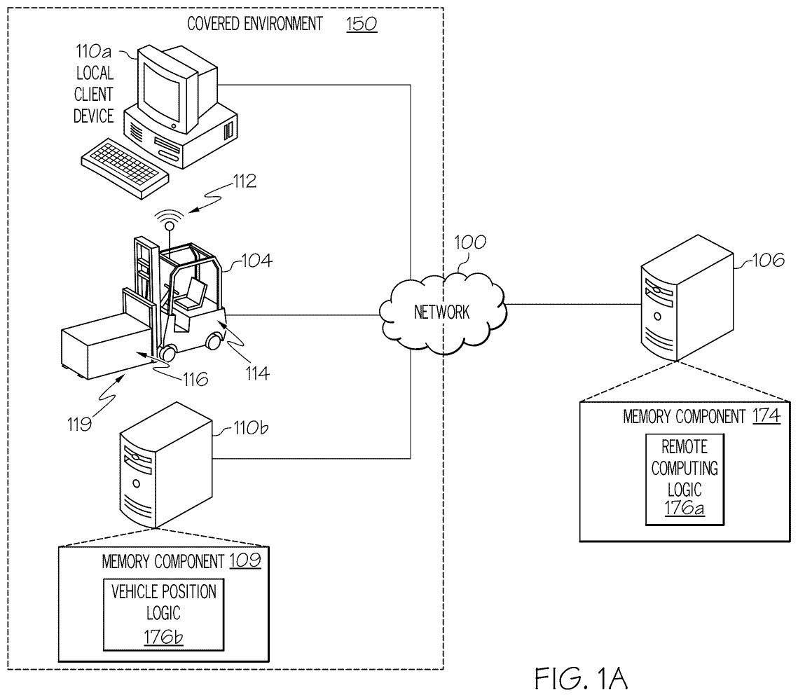

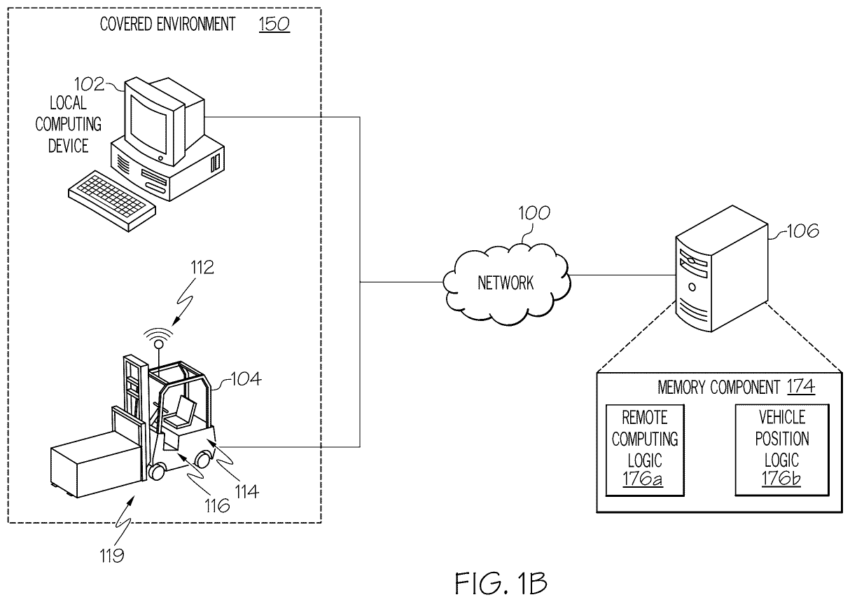

Referring now to the drawings, FIG. 1A depicts an environment-based computing environment for determining a position of a materials handling vehicle 104 within a covered environment 150, according to embodiments provided herein. As illustrated, the computing environment may include a network 100 coupled to components in the covered environment 150, such as the materials handling vehicle 104 and a local computing device 102. Also coupled to the network 100 is a remote computing device 106.

The materials handling vehicle 104 may be configured as a materials handling vehicle or other vehicle that is configured to traverse an industrial area, such as the covered environment 150 that includes objects, as described herein. In the context of the present disclosure, it is noted that a “materials handling vehicle” comprises a vehicle primarily designed for towing or lifting and moving a payload such as, for example, a warehouse tugger, a forklift vehicle, a reach vehicle, a turret vehicle, a walkie stacker vehicle, a tow tractor, a pallet vehicle, a high/low, a stacker-vehicle, trailer loader, a sideloader, a fork hoist, or the like.

The covered environment 150 may encompass any indoor or outdoor industrial facility in which materials handling vehicles 104 transport goods including, but not limited to, indoor or outdoor industrial facilities that are intended primarily for the storage of goods, such as those where multi-level racks are arranged in aisles, and manufacturing facilities where goods are transported about the facility by materials handling vehicles 104 for use in one or more manufacturing processes, as will be shown and described in more detail herein.

The materials handling vehicle 104 may include at least one vehicle sensor 114, which may be configured as a steering wheel sensor for detecting a steer angle, a wheel speed sensor for determining a speed of the materials handling vehicle 104 and/or for determining a direction of motion, such as whether the vehicle is moving forward or backward, an odometer, an onboard internal measurement unit (IMU), such as with an accelerometer and/or a gyroscope, (or more than one) for rotational movement of the materials handling vehicle 104 and/or detecting objects in the proximity of the materials handling vehicle 104, a radio frequency identifier (RFID), and/or a magnet or other wire guidance device for detecting an embedded wire in the covered environment 150. Depending on the particular embodiment, the vehicle sensor 114 may be configured as a 2-dimensional LiDAR system, a 3-dimensional LiDAR system, a RADAR system, a SONAR system, a camera system, and/or other device or system that can detect the presence of objects in the proximity of the materials handling vehicle 104. In some embodiments, the materials handling vehicle 104 includes only one vehicle sensor 114, while some embodiments are configured such that a plurality of vehicle sensors 114 are coupled to the materials handling vehicle 104 and provide a wide angle (e.g. 180 degree, 270 degree, 360 degree) view of objects around the materials handling vehicle 104.

Wheel speed and wheel angle may be sampled at a high rate and used to run a “dead reckoning” algorithm to estimate the displacement and rotation of the materials handling vehicle 104. This may utilize a recursive algorithm: so new wheel speed and wheel angle data may update the displacement and rotation further. This process results in an up-to-date position and rotation of the materials handling vehicle 104 that matches the sensor readings referred to herein as accumulated odometry.

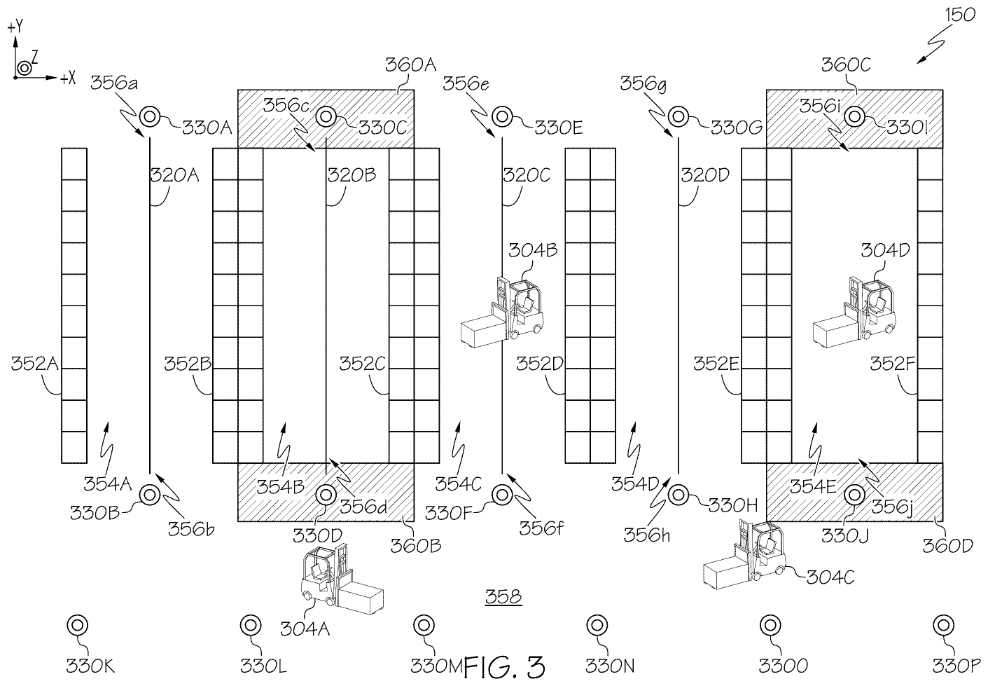

Gyroscope data (e.g., velocity rate of the materials handling vehicle 104 rotation) is sampled and integrated into a turn direction of the materials handling vehicle 104, referred to herein as accumulated gyro. This process may also utilize an accelerometer to sense the correct direction of rotation for the materials handling vehicle 104. The materials handling vehicle 104 may include a sensor for detecting whether the materials handling vehicle 104 is located proximate to a guidewire 320 (FIG. 3). If so, the materials handling vehicle 104 can enter a mode where the materials handling vehicle 104 is actively guided by a guidewire 320, such that vehicle movement is restricted to moving along the guidewire 320. When this occurs, the module responsible for guidewire navigation and operation will inform the vehicle computing device 116 that the vehicle is guidewire locked.

It should be understood that each of the LiDAR devices may be a LiDAR scanner capable of detecting objects in a field of view of the LiDAR scanner, such as, for example, the SICK TiM781, the SICK microScan3, or the IDEC SE2L. The remote computing device 106 may receive signals from the LiDAR device indicative of the detected object. The LiDAR devices may be mounted in various locations on the materials handling vehicle 104 to detect objects around the materials handling vehicle 104, such as, for example, a front, a rear, a top, a side, or the like.

In some embodiments, the materials handling vehicle 104 may include a first LiDAR device mounted on a front of the materials handling vehicle 104 and a second LiDAR device mounted on a rear of the materials handling vehicle 104. The first LiDAR device may detect objects in front of the materials handling vehicle 104 when the materials handling vehicle 104 is moving in a forward direction. The second LiDAR device may detect objects behind the materials handling vehicle 104 when the materials handling vehicle 104 is moving in a backwards direction. The materials handling vehicle 104 may include an operator compartment and a pair of forks for picking cargo within the manufacturing environment where the operator compartment and forks may be raised and lowered to pick cargo from shelves that are above the materials handling vehicle 104. The second LiDAR device may be mounted on a portion of the materials handling vehicle 104 separate from the operator compartment and forks that is not raised and lowered such that the second LiDAR device is disposed at a static distance away from the ground. When the operator compartment is lowered, the operator compartment may obstruct the view of the second LiDAR device. The materials handling vehicle 104 may be configured to raise the operator compartment to a predetermined height above the second LiDAR device when the materials handling vehicle 104 is moving in the backwards direction so that the operator compartment does not obstruct the view of the second LiDAR device.

The materials handling vehicle 104 may also include the vehicle transceiver 112 for communicating with a transceiver anchor 330 (FIG. 3) and/or with the remote computing device 106. As described in more detail below, some embodiments may be configured such that the covered environment 150 has a plurality of transceiver anchors 330 positioned at known fixed locations and broadcast a signal that includes an identifier of that transceiver anchor 330. A vehicle computing device 116 on the materials handling vehicle 104 and/or the remote computing device 106 may then determine a current location of the materials handling vehicle 104 from the received wireless communication. Specifically, the vehicle transceiver 112 may be configured to join a UWB network, which is managed by a service running on the memory component 174. The transceiver anchors 330 may be configured to send a beacon in preconfigured time slots (negotiated with a UWB network manager) to permit UWB location tracking; gather vehicle sensor data sent by the vehicle computing device 116 and append that information to the next beacon. Some embodiments may receive messages sent over the air from the vehicle position logic 176b and forward that data to the vehicle computing device 116, which contains policy enforcement requests.

The vehicle computing device 116 may be configured for recording and summarizing data from vehicle sensors 114 and forwarding the summarized vehicle sensor data to the vehicle transceiver 112. This includes gyroscope data, wheel sensing data, wire guidance state, etc. The vehicle computing device 116 may also interface with the vehicle transceiver 112, as well as send and receive messages to communicate with the network 100. The vehicle computing device 116 may also receive policy directives from the vehicle position logic 176b and determine when to apply those policies (policies may be sent proactively to avoid network latency).

The materials handling vehicle 104 may include a display (not explicitly shown in FIG. 1A) to provide one or more user interfaces. The materials handling vehicle 104 may include a proximity control module (PCM) as part of the vehicle computing device 116 that communicates with vehicle sensors 114 to arbitrate received data and provide command alerts and slowdowns to the materials handling vehicle 104 and equipped system components. The vehicle transceiver 112 may be configured as a UWB transceiver module that receives UWB network data and transmits vehicle data. The materials handling vehicle 104 may include a user option to calibrate and/or recalibrate a vehicle orientation.

Also included in FIG. 1A is the remote computing device 106. The remote computing device 106 may be configured as a personal computer, laptop, server, tablet, mobile device, vehicle computing device 116, and/or other computing device that includes the hardware and software for providing the functionality described herein. It should also be noted that some embodiments may be configured such that at least a portion of the computing described with reference to the remote computing device 106 is embodied in the vehicle computing device 116 that is integrated onto the materials handling vehicle 104 and/or otherwise provided locally from the covered environment 150.

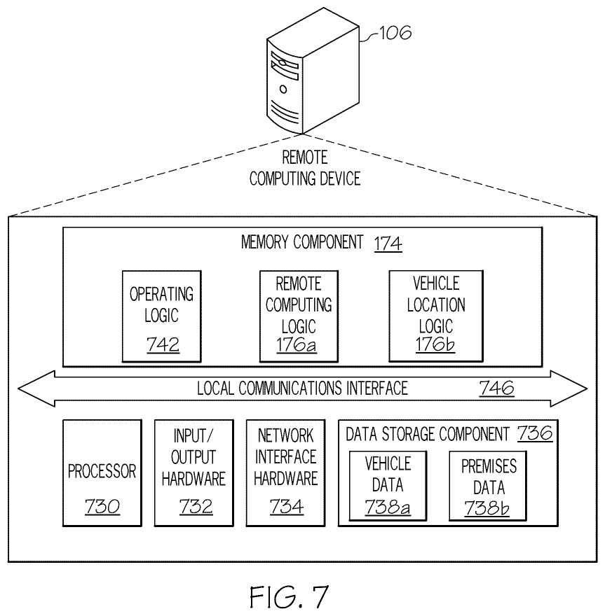

Regardless, the remote computing device 106 may include a plurality of components (described in more detail with reference to FIG. 7), such as a memory component 174. The memory component 174 may be configured as read access memory (RAM), read-only memory (ROM), registers, etc. The memory component 174 may be configured to store logic or other computer-readable instructions, such as remote computing logic 176a and vehicle position logic 176b. The remote computing logic 176a may include instructions for providing user interfaces to allow a user to define zones, as well as define the covered environment 150 that the zones apply. The vehicle position logic 176b may be part of a real time location tracking system (RTLS) that be configured to communicate with one or more transceiver anchors 314, wire guide systems, odometry systems, and/or other extra-vehicle systems to determine a real time location of the materials handling vehicle 104, as well as to store one or more tables for providing field shaping. More specifically, the vehicle position logic 176b may be configured to manage the network of transceiver anchors 330 (FIG. 3) to receive and locate the vehicle transceiver 112; execute the sensor fusion algorithm for tracking multiple the materials handling vehicles 104, 304; determine what policies should be enforced for the materials handling vehicle 104, 304 based on any number of tracked information (position, heading, speed, fork height, etc.).

The local computing device 102 may be configured as a desktop computer, laptop, tablet, mobile device, server, etc. In some embodiments, the local computing device 102 may be configured to provide administrative viewing and controls of the materials handling vehicle 104 and/or remote computing device 106. Other administrative controls may also be provided.

Also provided in the covered environment 150 is a local server 110b. The local server 110b, may be configured as a bridge, desktop computer, laptop, tablet, mobile device, server, etc. In some embodiments, the local server 110b may be configured to provide administrative viewing and controls of the materials handling vehicle 104 and/or remote computing device 106. Other administrative controls may also be provided. The local server 110b may include the memory component 109. The memory component 109 may store the vehicle position logic 176b, which may be configured to determine a location of the materials handling vehicle 104 within the covered environment 150 using one or more of a plurality of different technologies, such as UWB, wireless fidelity (Wi-Fi), wire guidance, cellular, etc. Thus, while the vehicle position logic 176b may be functionally similar to the vehicle position logic 176b from FIG. 1B, in FIG. 1A, the local server 110b may operate within or proximate the covered environment 150.

FIG. 1B depicts a cloud-based computing environment for determining a position of a materials handling vehicle 104 within a covered environment 150, according to embodiments provided herein. As illustrated, FIG. 1B is similar to FIG. 1A, except in FIG. 1B, the remote computing device 106 may house both the remote computing logic 176a and the vehicle positon logic 176b for providing the functionality provided herein.

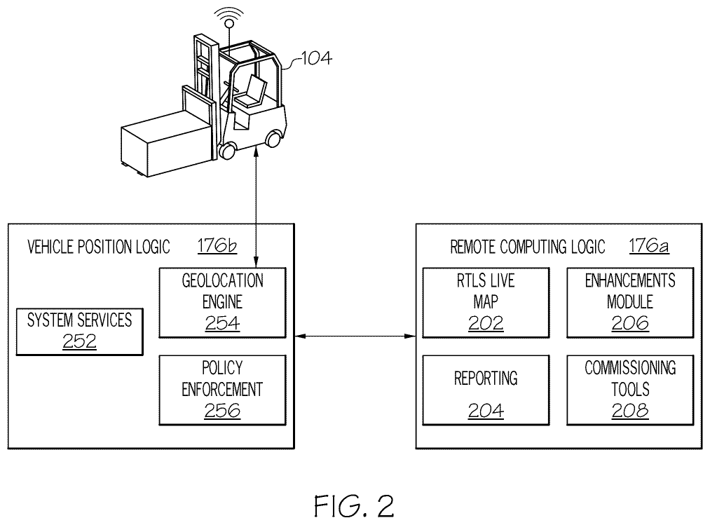

FIG. 2 depicts computing infrastructure associated with the remote computing logic 176a and the vehicle position logic 176b from FIGS. 1A and 1B, according to embodiments provided herein. As illustrated, the remote computing logic 176a may be configured as commercial management software application with RTLS features for users to monitor, manage, and maintain the system. As such, the remote computing logic 176a may be configured as an interface to the RTLS system. The remote computing logic 176a may be configured to allow for administrators to monitor, configure, update, and maintain the RTLS system. Additionally, those with lower rights are able to view RTLS data and report on the RTLS data. The remote computing logic 176a may include one or more modules, which may be implemented in hardware, software, and/or firmware. As illustrated, the remote computing logic 176a may include an RTLS live map 202, a reporting module 204, an enhancements module 206, a commissioning tools module 208. The RTLS live map 202 may be configured as a graphical facility map showing icons for real time locations of all active UWB devices on the network 100 (representing vehicles, pedestrians, and potentially materials and/or other equipment) as well as tools to dive deeper into information regarding facility, vehicle, operator, tag, wearable device, and/or user. The RTLS live map 202 communicates with other components on the network 100.

The reporting module 204 may provide API access to a user to generate its own reports as well as provide additional data as part of existing reports. In some embodiments, reporting module 204 may contain enhanced and/or additional built-in reports covering topics such as traffic and congestion, impacts and near-misses, route playback, etc. As such, the reporting module 204 may include an API module, a reports module, a heat maps module, a route playback module, and/or other modules for providing the functionality described herein.

The enhancements module 206 may provide options for users to enhance and/or manage alerts, notifications, equipment, user data, etc. associated with telematics services provided for the materials handling vehicle 104. This management may be configured to permit the RTLS system to work with the features provided herein.

The commissioning tools module 208 may include tools to setup and manage the virtual representation of the facility and zones where the system should exercise control and/or awareness to UWB tags (such as the materials handling vehicle 104, pedestrian tags, etc.). Additionally, the commissioning tools module 208 may be configured to provide tools to setup and manage the hardware and/or software on the downstream system components such as the server, anchors, and tags. These tools communicate to the other systems. Further, the commissioning tools module 208 may be configured to provide options for a user and/or administrator to define zones, design policies and/or rules associated with zones, as well as implement the zones, policies, and rules.

The vehicle position logic 176b may be the module where the bulk of tracking and control software resides to enable low latency, high accuracy vehicle tracking, vehicle reactions, and operator/user alerts. When implemented as hardware on-site (e.g., FIG. 1A), the vehicle position logic 176b may be configured as a physical server at the covered environment 150 dedicated to RTLS tasks. When implemented in the cloud (e.g., FIG. 1B), the vehicle position logic 176b may be configured as a virtual server in a cloud hosted data center off-site using third party machine computer capacity. The vehicle position logic 176b may be communicatively coupled to the transceiver anchors 314 (FIG. 3), which may be configured as UWB anchors which send/receive data wirelessly with the tag devices on the network. This data is then processed and distributed to the appropriate destination to the tag devices and/or through traditional networking to the components in the cloud.

As illustrated, the vehicle position logic 176b may include a system services module 252, a geolocation engine 254, and a policy enforcement module 256. The system services module 252 may be configured to monitor operation and/or health of RTLS components, which include hardware and/or software on the materials handling vehicle 104 that provide location tracking of the materials handling vehicle 104 (such as the anchors, tags, etc.). The system services module 252 may additionally be configured to setup, operate, and/or maintain the RTLS components. The system services module 252 may offer communication to and/or from the other system components such as the remote computing logic 176a and the materials handling vehicle 104, the materials handling vehicle 304, other vehicles, and/or pedestrians.

The geolocation engine 254 may be configured to manage UWB communications for the network 100, including high precision time syncing and location tracking. The geolocation engine 254 may include custom implementations of UWB software technologies to be employed for the RTLS features. Specifically, the geolocation engine 254 may be configured to utilize logical components (such as a sensor fusion algorithm) for monitoring the location of the materials handling vehicles 104, 304 (FIGS. 1, 3), as well as send commands to the materials handling vehicles 104, 304.

The materials handling vehicle 104 may also include a guidewire engagement system, floor guide rail system, a first position system, and/or a second position system. Specifically, some embodiments may operate without a guidewire system. As such, the guidewire engagement system may include one or more vehicle sensors for detecting a guidewire in a covered environment. The sensor may include a magnet, voltmeter, and/or other sensor for detecting a buried wire and/or electrical current created by the buried wire. The guidewire engagement system may also be configured to cause the materials handling vehicle 104 to engage with the detected guidewire such that vehicle control perpendicular to the guidewire is fixed such that the materials handling vehicle 104 is locked to one-dimensional control until disengaged from the guidewire. The first position system may include a UWB control system where a plurality of transceiver anchors 330 (FIG. 3) are visible to the materials handling vehicle 304. Because of the visual availability of the transceiver anchors 330, positioning determination and/or control may be accurately provided via the USB system. The second position system may be utilized to determine the location of the materials handling vehicle 104 when access to one or more transceiver anchors 330 is restricted. In practice, the first position system and the second position system may utilize similar or overlapping hardware with different weightings provided, based on whether the materials handling vehicle 304 is located in the free range area 358 or in an aisle 354.

FIG. 3 depicts an embodiment of the covered environment 150. The covered environment 150 may include a plurality of multi-level racking systems 352 (depicted as 352a-352f). Each of the plurality of multi-level racking systems 352 may be shaped and sized to allow for the storage of various storage units, including but not limited to boxes, totes, storage racks, etc. One or more aisles 354 (depicted as 354a-354e) may be formed between the pluralities of multi-level racking systems 352. Each of the aisles 354 may be shaped and sized to allow one or more materials handling vehicles 304 (depicted as 304a-304d) to transit therein. Each of the aisles 354 may include a pair of throats 356 (depicted as 356a-356j) formed at each end of the aisles 354. One or more of the aisles 354 may include a guidewires 320 (depicted as 320a-320d) that runs along the middle of each aisles 354 which runs from the pair of throats 356 formed at each end of the aisles 354.

It should be understood that while an aisle 354 may be an area between two multi-level racking systems 352, this is merely one example. As referred to herein, an aisle may include any area proximate an obstacle (one or more) that restricts a line of sight to a transceiver anchor 330. Stated another way, an aisle is any area in the covered environment 150 that has distressed coverage. As an example, an aisle may include an inside of a shipping vehicle, where the obstacles are the walls of the shipping vehicle.

The covered environment 150 may include a free range area 358. The free range area 358 may be a portion of the covered environment 150 outside the one or more aisles 354 which is relatively free from restrictions and obstructed areas. A plurality of transceiver anchors 330 (depicted as 330a-330p) may be positioned at known fixed locations within the covered environment 150 and communicate with a materials handling vehicle 304, as described in more detail below.

In operation, the vehicle transceiver 112 emits a beacon signal that can be uniquely identified to the individual vehicle transceiver 112 that sent the signal. In some embodiments, this beacon includes on-vehicle summarized sensor data. Each transceiver anchor 330 that receives the beacon, records the time when the beacon was received (the receive timestamp or RX timestamp). The clock that is used to timestamp the receive timestamp is kept in sync between all the transceiver anchors 330 so the beacons are comparable to one-another. Each transceiver anchor 330 sends the receive timestamp and the beacon data (which includes the on-vehicle summarized sensor data) to the vehicle position logic 176 which conducts the sensor fusion.

While the materials handling vehicle 304 is transiting the free range area 358, a two-dimensional position of the materials handling vehicle 304 may be determined based on the signals received from one or more of the plurality of transceiver anchors 330. The position of the materials handling vehicle 304 may be formatted as coordinates, such as along an X-Y grid.

In some embodiments, when one of the materials handling vehicles 304, such as the materials handling vehicle 304a, is travelling within the free range area 358 the two-dimensional position of the materials handling vehicle 304a may be determined based on the signals received from four of the plurality of transceiver anchors 330. However, it should be understood that in some embodiments, the two-dimensional position of the materials handling vehicle 304 may be determined based on any suitable number of transceiver anchors 330, including but not limited to two transceiver anchors 330, three transceiver anchors 330, four transceiver anchors 330, five transceiver anchors 330, etc. As illustrated, sixteen transceiver anchors 330 are included in the covered environment 150 of FIG. 3, however it should be understood that in some embodiments, any suitable number of transceiver anchors 330 may be included.

A pair of the plurality of transceiver anchors 330 may be arranged adjacent to the pair of throats 356 formed at each end of each of the one or more aisles 354. As illustrated, transceiver anchors 330a and 330b are arranged adjacent to the aisle 354a, transceiver anchors 330c and 330d are arranged adjacent to the aisle 354b, transceiver anchors 330e and 330f are arranged adjacent to the aisle 354c, transceiver anchors 330t and 330f are arranged adjacent to the aisle 354d, and transceiver anchors 330i and 330j are arranged adjacent to aisle 354e. Guidewires 320 and/or a floor guide rail system may be placed along a length of at least one of the aisles 354. Each of the plurality of guidewires 320 may be embedded within a floor of the covered environment 150.

When one of the materials handling vehicles 304 is travelling within one of the aisles 354 which has one of the plurality of guidewires 320 embedded therein, such as the illustrated materials handling vehicle 304b, the materials handling vehicle 304b may associate the X-direction position of the two-dimensional position of the materials handling vehicle 304 with the position associated with the signal broadcast by the one of the plurality of guidewires 320, as will be described in more detail herein. In some embodiments, when one of the materials handling vehicles 304 receives signals broadcast from a plurality of the guidewires 320, the materials handling vehicle 304 may associate the two-dimensional position of the materials handling vehicle 304 with the guidewire 320 closer in proximity to the materials handling vehicle 304.

In some embodiments, when one of the materials handling vehicles 304 is within a predetermined distance of one of the plurality of guidewires 320, the materials handling vehicle 304 may transition from a first position determining system to a second position determining system, as is described in more detail herein.

The covered environment 150 may include one or more transition zones 360. Each of the one or more transition zones 360 may be located adjacent to one of the one or more throats 356 of the one or more aisles 354. While the transition zones 360 are illustrated as thatched areas and may be visually represented in the covered environment 150, it should be understood that some embodiments may be configured with the transition zones 360 as virtual areas detectible by the materials handling vehicle 304 but otherwise not visible to a human. Further, while the transition zones 360 are displayed as rectangular in shape, it should be understood that the transition zones 360 may be any suitable shape, such as a semi-circle, a triangle, a hexagon, etc.

The transition zones 360 may be detected by the one or more materials handling vehicles 304 based on the determined position of the one or more materials handling vehicles 304. When the one or more materials handling vehicles 304 determines they are entering or exiting a transition zone 360, such as the illustrated materials handling vehicle 304c, the materials handling vehicle 304c may transition between control systems, position determining systems, slow down the materials handling vehicle 104, or perform other suitable functions, as will be described in more detail herein.

In operation, as the materials handling vehicle 304 is traversing the covered environment 150, the vehicle transceiver 112 (FIG. 1) may emit a beacon signal that can be uniquely identified to the individual vehicle transceiver 112 that sent the signal. This beacon may include on-truck summarized sensor data. Each transceiver anchor 330 that receives the beacon records a timestamp of when the beacon was received. The clock that is used to create the timestamp is kept in sync between all of the transceiver anchors 330 so is comparable to one-another. Each transceiver anchor 330 sends the timestamp and the beacon data (which includes the vehicle summarized sensor data) to the vehicle position logic 176b (FIGS. 1, 2), which conducts sensor fusion. In the free range area 358, communication from the vehicle transceiver 112 can be received by many transceiver anchors 330 (e.g., greater than 3-4 transceiver anchors 330) from many different angles. In the confined areas of the aisles 354 or within some travel corridors the vehicle transceiver 112 may only be heard by a subset of the plurality of transceiver anchors 330 (two or fewer transceiver anchors 330, three transceiver anchors 330, four transceiver anchors 314, etc.) and from an approximate single axis (e.g., along the aisle 354). When two or more transceiver anchors 330, a time of flight differential algorithm may be utilized to determine the missing dimension of the position of the materials handling vehicle 104. Specifically, a time of flight may be determined from a first transceiver anchor 330 to the materials handling vehicle 104 and a time of flight may be determined from a second transceiver anchor 330. The difference in the times may be compared to determine the dimension.

This alignment contributes to higher error in traditional time difference of arrival (TDoA) algorithms called the geometric dilution of precision (GDoP) in the aisles 354. Accordingly, sensor fusion, as described herein may include passing the data to the sensor fusion algorithm, which may be part of the vehicle position logic 176b: TDoA position of the vehicle transceiver 112 (x, y) in the coordinate frame, quality metric related to the accuracy of the TDoA tracked position, timestamps, unique ID, and a quality metric relating to signal reception of each transceiver anchor 330 that received the beacon of the vehicle transceiver 112, accumulated odometry (x, y, heading) in an arbitrary coordinate frame as reported from the vehicle computing device 116 (FIG. 1) at the time of the beacon, an accumulated gyro heading in an arbitrary coordinate frame as reported from the vehicle computing device 116 at the time of the beacon, and a guidewire locked state reported from the vehicle computing device 116 at the time of the beacon.

The sensor fusion algorithm blends the above listed information with past observations from these sources using a recursive state estimation filter. Some embodiments utilize an Unscented Kalman Filter (UKF) but other processes can be used (e.g., Kalman Filter, Extended Kalman Filter, sequential Monte Carlo, factor graphs, etc.). Specifically, the state of the materials handling vehicle 104, 304 may be tracked by the filter is:

1) The position (x, y) of the materials handling vehicle 104 within the covered environment 150. 2) The orientation or facing direction of the materials handling vehicle 104 within the covered environment 150. 3) The coordinate offset of the accumulated gyroscope data. This is not reported out but internally used to track and offset the bias and random walk errors of a MEMS gyroscope.

As such, embodiments provided herein may perform the following process: UKF prediction, UKF measurement, free range UKF measurement, and in-aisle UKF measurement. UKF prediction includes estimating the UKF state at the time sensor observations are captured. Many filters use current velocity, Newtonian motion (conservation of inertia), and user control inputs to model this UKF prediction. As such, embodiments utilize accumulated odometry or the directly observed movement from the vehicle wheels to perform this. Accumulated odometryₜ₋₁ is compared with the accumulated odometry to determine the how the truck has physically moved in the time between the updates. The physical movement is applied to the sigma points within the UKF unscented transform in order to determine the probable location and heading of the truck at the time of the sensor observations. Various parameters like the time between beacon timestampₜ₋₁ and beacon timestampₜ, magnitude of vehicle displacement, and guidewire lock can influence the noise parameters of the transform, which allows the filter to balance the certainty of the prediction against the sensor observations. Of particular note when the materials handling vehicle 104 is guidewire locked only the component of movement along the length of the guidewire 320 is used as part of this update.

The coordinate offset of a gyroscope may be predicted separately according to a random walk model with error terms derived from an IMU data sheet and experimentation. This error term may depend on the time between the update t−1 and t (as gyroscope random walk error and integration error grows with time), the magnitude of the change in orientation between t−1 and t, and how long has elapsed since the gyroscope was recalibrated by the vehicle computing device 116.

UKF measurement includes utilizing an internal sensor model to predict each sensor observation from the predicted UKF state (see UKF prediction above). The predicted sensor output is then compared with the real-world observations and an uncertainty of the observation to make an innovation matrix. This innovation matrix describes how correct or incorrect the predicted UKF state, given the measurements observed. Through the UKF algorithm, this is applied back to the UKF state to correct errors and derive an over-all more accurate final prediction of the current state of the materials handling vehicle 104. This correction is applied for sensor inputs across the UKF state, which is ultimately responsible for blending the sensor data together to obtain a combined and more accurate state.

When the materials handling vehicle 304 is within a free range area 358, the TDoA derived position of the vehicle transceiver 112 is very accurate. A simple measurement update can be used that saves time on the memory component 174 and has proven by experimentation to be more robust than in-aisle UKF measurement. In this mode, guidewire locked status may be ignored. Embodiments provided herein may use the guidewire state to switch between this mode and in-aisle UKF measurement. The UWB location measurement model simply corrects for the vehicle transceiver 112 offset from the tracked center of the materials handling vehicle 304 known as the kinematic center. The 3-dimensional offset is known from data reported from the vehicle computing device 116 from preconfigured values or querying on-vehicle systems; from data configured within the memory component 109 via a truck model lookup or by a unique identifier per materials handling vehicle 304; and/or data supplied by the memory component 174, which may have access to manufacturing records on the materials handling vehicle 104. The uncertainty for the measurement can depend on the reported quality of the TDoA position, the reported time synchronization accuracy of transceiver anchors 330 used in the calculation, or metrics derived from comparing the observation to previous measurements. The gyro measurement model is simply the orientation or facing direction of the materials handling vehicle 104, minus the coordinate offset of the accumulated gyroscope data, as any heading change sensed by the gyroscope should have already been accounted for in UKF prediction.

The uncertainty of the measurement can depend on the time between the update time t−1 and t (as the gyroscope random walk error and integration error grows with time), the magnitude of the change in orientation between t−1 and t, and how long it has been since the gyroscope was recalibrated by the vehicle computing device 116.

In-aisle UKF measurement is designed to operate when TDoA derived position of the vehicle transceiver 112 is not accurate independent of other sensors. In this mode, the receive timestamps of the individual transceiver anchors 330 are utilized along with a guidewire constraint to more accurately model errors associated with a low number of observations by the transceiver anchors 330 with often high GDoP. This mode is not only usable with two anchors at the end of an aisle 354, so can seamlessly handle a transceiver anchor 330 midway down the aisle 354 and combine the data with the two anchors on the end of the aisle 354.

Each transceiver anchor 330 received timestamp is treated as its own individual measurement model. The exact model is derived from the underlying math of TDoA localization. Some embodiments utilize a single transceiver anchor 330 as a benchmark. Other transceiver anchors 330 may be compared to this benchmark and can provide a measurement referred to as a delta range. The “N” receive timestamps are turned into “N−1” delta ranges, which may be used as the measurement in the UKF filter. If only one transceiver anchor 330 receive timestamp is received, the update will run with no transceiver anchor 330 measurements. Outside of this calculation, other processes may be used to prune or affect the measurement noise model of non-ideal receive timestamp observations. These processes may include non-line-of-sight detection, vehicle shading, antenna reception models, quality of signal, and quality of time synchronization.

Specifically, the non-line-of-sight detection includes using the predicted pose of the UKF to determine if racking or other mapped obstacles are in between the vehicle transceiver 112 and the particular transceiver anchor 330. Vehicle shading includes using the lift height of the materials handling vehicle 304 to determine if some transceiver anchors 330 would have been interfered with by the staging mast or load on the materials handling vehicle 304. Antenna reception models includes having non-linear reception characteristics due to the construction of the antenna of the vehicle transceiver 112 and transceiver anchors 330. Using the predicted pose of the UKF, the estimated impact of this affect can be determined and a compensation may be made. The quality of signal includes the reported quality of the received beacon message's signal. The quality of time synchronization includes the reported quality of the time synchronization of the anchor that is recording the transceiver anchor 330 receive timestamp.

The measurement model predicts the delta range for each received timestamp by using the known offset of the vehicle transceiver 112 (as described with free range UKF measurement) and the pre-mapped positions of the transceiver anchors 330 used to calculate the delta range. The guidewire measurement may be split into two constraints to make the formulation in the UKF easier. This is not necessary to achieve the same underlying constraint.

The position offset constraint is formulated as a displacement from the side of the guidewire 320 to be 0 meters. The measurement model may be configured to find the proximate guidewire 320 to the UKF predicted position and then calculate the distance of the predicted position perpendicular to the wire. The uncertainly of this measurement may be low, indicating high certainty and a high weighting in the overall UKF algorithm. This means that when a materials handling vehicle 304 is guidewire locked, the UKF will correlate the correct position of the materials handling vehicle 304 as one that has 0 distance off the left or right side of the guidewire 320.

The heading offset constraint may be formulated in a similar manor. The measurement is formulated as a global heading offset from the guidewire 320, which may be 0 degrees. The measurement model may be configured to find the proximate guidewire 320 to the UKF predicted position and then calculate the difference between the heading of the materials handling vehicle 304 and the direction of the guidewire 320. The uncertainty of this measurement may be low, to indicate high certainty and high weighting in the overall UKF algorithm. This means that when a materials handling vehicle 304 is guidewire locked, the UKF may strongly correlate the correct heading of the materials handling vehicle 304 as one that is aligned with the wire direction (for instance on guidewire 320c the materials handling vehicle 304b is constrained to face pointing towards the +Y or −Y axis).

The accumulated gyroscope model does not change between this mode and the free range mode. In expression, the high certainty in the heading from the guidewire 320 will help decouple the materials handling vehicle 304 heading and gyroscope coordinate offset state terms that are otherwise tightly coupled, keeping the UKF more stable for long-term operation.

Additionally, some embodiments may be configured to detect an in-aisle condition by the UKF predicted pose crossing a throat 356 that defines an aisle 354. These embodiments may utilize an aisle constraint that is similar to the guidewire constraint. This may include detecting an aisle 354 situation using the received signal characteristics from the vehicle transceiver 112 and/or or the transceiver anchors 330. Additionally, these embodiments may expand usage of in-aisle measurement to cover free-range areas, which reduce the need to switch operational modes. This may be performed in combination with the other options above.

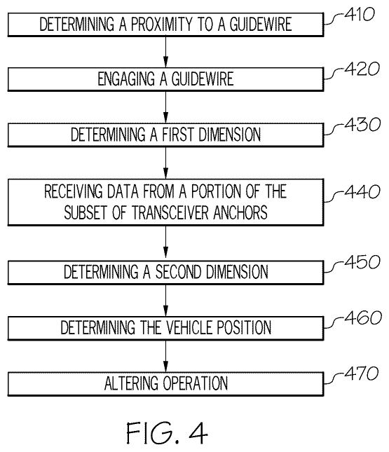

FIG. 4 depicts a flowchart for tracking a two dimensional position of the materials handling vehicle 304, according to embodiments provided herein. As illustrated in block 410, a proximity of the vehicle to a guidewire 320 is determined. In some embodiments, this might include crossing one of the transition zones 360 between the free range area 358 and one of the plurality of aisles 354. In the example of FIG. 3, the materials handling vehicle 304c enters the transition zone 360d adjacent to the aisle 354e.

In some embodiments, the materials handling vehicle 304 and/or the remotely located computing device may automatically initiate determining the position of the materials handling vehicle 304, such as when the materials handling vehicle 304 enters the transition zone 360. In further embodiments, the materials handling vehicle 304 may manually initiate determining the position of the materials handling vehicle 304 when the materials handling vehicle 304 receives an input on the user interface.

In block 420, the materials handling vehicle 304 may engage with the proximate guidewire 320. By engaging with the proximate guidewire 320, the materials handling vehicle 304 may use the field created by the guidewire 320 to control and/or limit control of the materials handling vehicle 104 to remain within a predetermined distance of the guidewire 320.

In block 430, a first dimension of a position of the materials handling vehicle 304 may be determined based on the signals generated by the one or more position sensors 119 (FIG. 1). That is, the one or more position sensors 119 (FIG. 1) may generate data as the materials handling vehicle 304 transits within one of the plurality of aisles 354. The materials handling vehicle 304 may use the recent location prior to entering the aisle 354, such as the location generated by the signals received from the plurality of transceiver anchors 330 when the materials handling vehicle 304 transits the free range area 358 of the covered environment 150 to determine which guidewire 320 is the proximate guidewire 320. Knowing the proximate guidewire 320 yields the first dimension.

In some embodiments discussed in relation to FIG. 3, the materials handling vehicle 304d is shown transiting within the aisle 354e. The materials handling vehicle 304d crossed one of the transition zones 360, such as the transition zone 360d prior to entering the aisle 354e. The materials handling vehicle 304d may utilize the one or more position sensors 119 (FIG. 1) to determine the odometry or other data from the last known X-dimension of the position of the materials handling vehicle 304d to determine the current X-dimension of the position of the materials handling vehicle 304d.

In some embodiments where the materials handling vehicle 304d has a plurality of position sensors 119 (FIG. 1) associated therewith, the materials handling vehicle 304d and/or the remotely located computing device may compare and weigh the data generated by each position sensor 119 according to sensor fusion described above to better determine the X-dimension of the position of the materials handling vehicle 304d.

In block 440, data from a portion of the subset of transceiver anchors may be received. In block 450, a second dimension of the position may be determined from a time of flight analysis of the data received from the subset of transceiver anchors 330.

Referring again to the embodiment discussed in relation to FIG. 3, the materials handling vehicle 304d and/or the remotely located computing device associates the Y-direction of the materials handling vehicle 304d based on the location data determined from communication with the transceiver anchors 330i and 330j. The materials handling vehicle 304d communicates with the transceiver anchors 330i and 330j to determine the Y-direction of the position of the materials handling vehicle 304d. The materials handling vehicle 304d and/or the remotely located computing device uses this information to determine the X and Y-dimensions of the two dimensional position of the materials handling vehicle 304d.

In block 460, the position may be determined from the first dimension and the second dimension. Upon determination of the position in block 470, embodiments may alter operation of the materials handling vehicle 304d. As an example, control in the Y-dimension may be handed over to the vehicle computing device 116 for autonomous operation. In some embodiments, partial automation may be employed. In still some embodiments, control of the materials handling vehicle 304 may remain with the operator, but may be overtaken if the vehicle computing device 116 determines the operator is not properly controlling the materials handling vehicle 304.

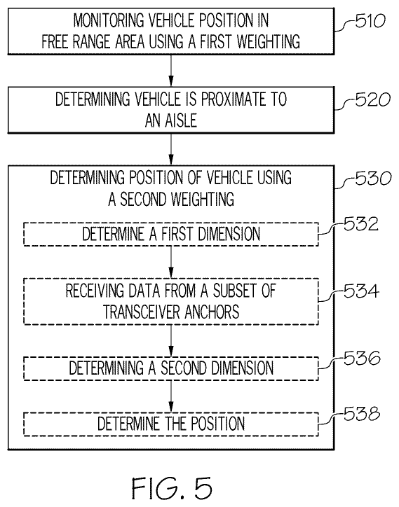

FIG. 5 depicts a flowchart for tracking a two-dimensional position of the materials handling vehicle 304 using sensor fusion, according to embodiments provided herein. As illustrated in block 510, the position of the materials handling vehicle 304 may be monitored in the free range area 358 of the covered environment 150 using a first data weighting that primarily favors data received from the plurality of transceiver anchors 330. As described above, the when the transceiver anchors 330 are unobstructed, embodiments provided herein may primarily utilize data from the transceiver anchors 330 in determining vehicle location. In block 520, the materials handling vehicle 304 may be determined as being proximate to an aisle 354. This determination may be made based on a location and/or a determination that the materials handling vehicle 304 is entering an aisle, a transition zone, and/or a restriction zone. In block 530, in response to determining that the materials handling vehicle 304 is within a predetermined distance to the aisle 354, the position of the materials handling vehicle 304 may be determined via a second data weighting. In some embodiments, determining the position utilizing the second data weighting may include blocks 532, 534, 536, and 538. As illustrated in block 532, a first dimension of the position of the materials handling vehicle 304 may be determined based primarily on data generated by the one or more vehicle sensors 114. In block 534, data may be received via the vehicle transceiver 112 from a subset of transceiver anchors 330 of the plurality of transceiver anchors 330, where the subset of transceiver anchors 330 are positioned with line of sight along the aisle 354. In block 536, a determination may be made regarding a second dimension of the position of the materials handling vehicle 304 that is primarily based on the received data via the vehicle transceiver 112. In block 538, the position of the materials handling vehicle 304 may be determined from the first dimension and the second dimension. In some embodiments, an alteration of the materials handling vehicle 304 may also be made.

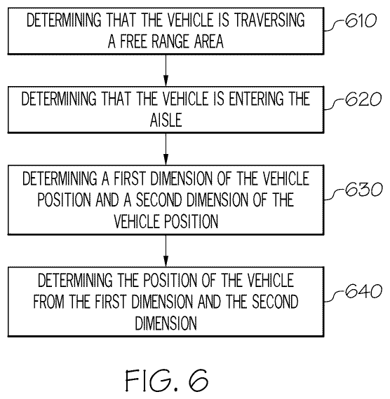

FIG. 6 depicts a flowchart for transitioning a control system of the materials handling vehicle 304, according to embodiments provided herein. As illustrated in block 610, a position of a materials handling vehicle 304 in a free range area 358 of the covered environment 150 may be determined. That is, the materials handling vehicle 304 may be transiting within the free range area 358 of the covered environment 150 under the first position system. The first position system may include a UWB control system where a plurality of transceiver anchors 330 (FIG. 3) are visible to the materials handling vehicle 304. As discussed above, because of the visual availability of the transceiver anchors 330, positioning determination and/or control may be accurately provided via the USB system.

In some embodiments, the materials handling vehicle 304a may be transiting within the free range area 358 under the first position system. The first position system may be a UWB system (or other system) that utilizes the three or more transceiver anchors 330 for determining both the first dimension and the second dimension of the location of the materials handling vehicle 304.

In block 620, a determination may be made that the materials handling vehicle 104 is entering an aisle, a transition zone, and/or a restriction zone. In some embodiments this may include determining that the materials handling vehicle 104 is entering a transition zone 360 between the free range area 358 and one of the aisles 354. The materials handling vehicle 304 may cross into one of the transition zones 360 adjacent to one of the aisles 354. As illustrated, the materials handling vehicle 304c is shown entering the transition zone 360d.

In some embodiments, the materials handling vehicle 304 and/or the remotely located computing device may generate an alert when the materials handling vehicle 304 enters the transition zone 360 and/or aisle 354. The alert may be a sound, a light, a buzzer, or any other suitable type of alert. The alert may notify the operator that the materials handling vehicle 304 is changing position systems (and/or the weighting of position systems), as is discussed in more detail below. In some embodiments, the materials handling vehicle 304 may automatically slow down when the materials handling vehicle 304 enters the transition zone 360.

In block 630, in response to determining that the materials handling vehicle 304 is entering an aisle, a transition zone, and/or a restriction zone, a first dimension of the materials handling vehicle 304 and a second dimension of the materials handling vehicle 304 may be determined. As described elsewhere herein, the first dimension may be determined via a known location of a guidewire 320 that is closest to the materials handling vehicle 304 upon entering the restriction zone. The second dimension may be determined via communication with a subset of the transceiver anchors 330 that are available to the materials handling vehicle 304. In block 640, the position of the materials handling vehicle 304 may be determined from the first dimension and the second dimension.

Specifically, some embodiments provided herein may include two position systems to identify the location of the materials handling vehicle 304. The first position system may determine the location of the materials handling vehicle 304 in the free range areas 358. The second position system may be utilized to determine the location of the materials handling vehicle 104 when access to one or more transceiver anchors 330 is restricted. In practice, the first position system and the second position system may utilize similar or overlapping hardware with different weightings provided, based on whether the materials handling vehicle 304 is located in the free range area 358 or in an aisle 354.

The materials handling vehicle 304 therefore may transit the first area of the covered environment 150 under the first position system and the second area of the covered environment 150 under the second position system. As described above, the second position system may be a wireline control system for a first dimension of travel (e.g., the X-dimension), while motion of the materials handling vehicle 304 in the Y direction may still be controlled by an operator. As such, the second position system may utilize different protocols for each dimension of the position and/or control of the materials handling vehicle 304. Additionally, positioning under the second position system may be determined by determining the guidewire 320 to which the materials handling vehicle 104 is coupled for the X-dimension and UWB may be utilized to determine the Y-dimension of the location of the materials handling vehicle 304.

FIG. 7 depicts a remote computing device 106 for providing guidance, according to embodiments provided herein. As illustrated, the remote computing device 106 includes a processor 730, input/output hardware 732, a network interface hardware 734, a data storage component 736 (which stores vehicle data 738a, premises data 738b, and/or other data), and a memory component 174. The memory component 174 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD) (whether local or cloud-based), and/or other types of non-transitory computer-readable medium. Depending on the particular embodiment, these non-transitory computer-readable mediums may reside within the remote computing device 106 and/or external to the remote computing device 106.

The memory component 174 may store operating logic 742, the remote computing logic 176a and the vehicle position logic 176b. Each of these logic components may include a plurality of different pieces of logic, each of which may be embodied as a computer program, firmware, and/or hardware, as an example. A local interface 746 is also included in FIG. 7 and may be implemented as a bus or other communication interface to facilitate communication among the components of the remote computing device 106.

The processor 730 may include any processing component operable to receive and execute instructions (such as from a data storage component 736 and/or the memory component 174). As described above, the input/output hardware 732 may include and/or be configured to interface with speakers, microphones, and/or other input/output components.

The network interface hardware 734 may include and/or be configured for communicating with any wired or wireless networking hardware, including an antenna, a modem, a LAN port, wireless fidelity (Wi-Fi) card, WiMAX card, mobile communications hardware, transceiver, and/or other hardware for communicating with other networks and/or devices. From this connection, communication may be facilitated between the remote computing device 106 and other computing devices.

The operating logic 742 may include an operating system and/or other software for managing components of the remote computing device 106. As discussed above, the remote computing logic 176a may be configured to cause the processor 730 to provide user interfaces, define zones, and/or perform other actions, as described herein. The vehicle position logic 176b may be configured to cause the processor 730 to utilize transceiver anchors 314 and/or other technologies to determine a location of the materials handling vehicle 104 in the covered environment 150, as well as provide and apply field shaping.

It should be understood that while the components in FIG. 7 are illustrated as residing within the remote computing device 106, this is merely an example. In some embodiments, one or more of the components may reside external to the remote computing device 106 or within other devices, such as the materials handling vehicle 104, the local computing device 102, the local client device 110a, and/or the local server 110b depicted in FIGS. 1A, 1B. It should also be understood that, while the remote computing device 106 is illustrated as a single device, this is also merely an example. In some embodiments, the remote computing logic 176a and/or the vehicle position logic 176b may reside on different computing devices.

As an example, one or more of the functionalities and/or components described herein may be provided by the remote computing device 106, the materials handling vehicle 104, the local computing device 102, the local client device 110a, and/or the local server 110b. Depending on the particular embodiment, any of these devices may have similar components as those depicted in FIG. 7. To this end, any of these devices may include logic for performing the functionality described herein.

Additionally, while the remote computing device 106 is illustrated with the remote computing logic 176a and the vehicle position logic 176b as separate logical components, this is also an example. In some embodiments, a single piece of logic may provide the described functionality. It should also be understood that while the remote computing logic 176a and the vehicle position logic 176b are described herein as the logical components, this is also an example. Other components may also be included, depending on the embodiment.

As illustrated above, various embodiments are disclosed. These embodiments may be configured to create and implement shaped detection fields around a materials handling vehicle. These embodiments improve the functioning of a materials handling vehicle by customizing these virtual shaped detection fields that the materials handling vehicle utilizes to automatically and without user input adjust operation.

While particular embodiments and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the embodiments shown and described herein.

It should now be understood that embodiments disclosed herein include systems, methods, and non-transitory computer-readable mediums for systems and methods for determining the position of a materials handling vehicle within a covered environment. It should also be understood that these embodiments are merely exemplary and are not intended to limit the scope of this disclosure.

What is claimed is:

1. A materials handling vehicle comprising:
a vehicle transceiver for receiving a communication from a plurality of transceiver anchors that are placed on respective stationary objects within a covered environment and one or more vehicle sensors;
a computing device that includes a processor and a memory component, the memory component storing logic that, when executed by the processor, causes the materials handling vehicle to perform the following:
determine a first dimension of a position of the materials handling vehicle based on data generated by the one or more vehicle sensors;
receive, via the vehicle transceiver, data from a subset of transceiver anchors of the plurality of transceiver anchors;
determine a second dimension of the position of the materials handling vehicle based on the received data via the vehicle transceiver;
determine the position of the materials handling vehicle from the first dimension and the second dimension; and
alter operation of the materials handling vehicle based on the position.

2. The materials handling vehicle of claim 1, wherein the one or more vehicle sensors comprises at least one of the following; a gyroscope, an accelerometer, a steering wheel sensor, a magnet, or a wheel speed sensor.

3. The materials handling vehicle of claim 1, wherein the materials handling vehicle includes at least two different types of vehicle sensors and signals generated by each of the at least two different types of vehicle sensors are weighted into an output interpreted by at least one of the following: the materials handling vehicle or a remotely located computing device.

4. The materials handling vehicle of claim 1, wherein the materials handling vehicle includes a user option to manually alter a weighting of using the vehicle transceiver to determine the first dimension.

5. The materials handling vehicle of claim 1, wherein the subset of transceiver anchors are positioned with line of sight to the materials handling vehicle along an aisle, wherein a weighting of using the vehicle transceiver to determine the first dimension is automatically changed in response to determining that only the subset of transceiver anchors have line of sight to the materials handling vehicle when the materials handling vehicle is located at a predetermined position.

6. The materials handling vehicle of claim 5, wherein the predetermined position includes at least one of the following: a transition zone or a restriction zone.

7. The materials handling vehicle of claim 1, wherein altering operation of the materials handling vehicle includes at least one of the following: changing a speed of the materials handling vehicle, limiting operation of a fork of the materials handling vehicle, or generating an alert to an operator of the materials handling vehicle.

8. The materials handling vehicle of claim 1, wherein the vehicle transceiver is an ultra-wide band (UWB) transceiver.

9. The materials handling vehicle of claim 1, wherein the logic further causes the materials handling vehicle to determine a proximity of the materials handling vehicle to an aisle.

10. The materials handling vehicle of claim 1, wherein altering operation of the materials handling vehicle includes at least one of the following: engaging an autonomous mode, engaging a semi-autonomous mode, or engaging a manual mode.

11. A system comprising:
a materials handling vehicle that includes a vehicle transceiver for receiving a communication from a plurality of transceiver anchors that are placed on respective stationary objects within a covered environment and one or more vehicle sensors; and
a remotely located computing device in communication with the materials handling vehicle that includes a processor and a memory component, the memory component storing logic that, when executed by the processor, causes the system to perform the following:
determine a first dimension of a position of the materials handling vehicle based on data generated by the one or more vehicle sensors;
receive, via the vehicle transceiver, data from a subset of transceiver anchors of the plurality of transceiver anchors;
determine a second dimension of the position of the materials handling vehicle based on the received data from a via the vehicle transceiver;
determine the position of the materials handling vehicle from the first dimension and the second dimension; and
alter operation of the materials handling vehicle, based on the position.

12. The system of claim 11, wherein the one or more vehicle sensors comprises at least one of the following: a gyroscope, an accelerometer, a steering wheel sensor, a wire guidance device, or a wheel speed sensor.

13. The system of claim 11, wherein the materials handling vehicle includes at least two different types of vehicle sensors and signals generated by each of the at least two different types of vehicle sensors are weighted into an output interpreted by the materials handling vehicle.

14. The system of claim 11, wherein the materials handling vehicle includes a user option to manually alter a weighting of using the vehicle transceiver to determine the first dimension.

15. The system of claim 11, wherein the subset of transceiver anchors are positioned with line of sight to the materials handling vehicle along an aisle, wherein a weighting of using the vehicle transceiver to determine the first dimension is automatically changed in response to determining that only the subset of transceiver anchors have line of sight to the materials handling vehicle.

16. The system of claim 11, wherein the materials handling vehicle further includes at least one of the following: a wire guidance device for engaging wire guidance in an aisle or a floor guide rail system.

17. The system of claim 11, wherein the vehicle transceiver is an ultra-wide band (UWB) transceiver.

18. A method for determining a position of a materials handling vehicle in a covered environment, wherein the materials handling vehicle includes a vehicle transceiver for communicating with a plurality of transceiver anchors in the covered environment, wherein the materials handling vehicle includes one or more vehicle sensors, comprising:
monitoring, by a computing device, the position of the materials handling vehicle in a free range area of the covered environment using a first data weighting that primarily favors data received from the plurality of transceiver anchors;
determining, by the computing device, the position of the materials handling vehicle via a second data weighting that includes the following:
determining, by the computing device, a first dimension of the position of the materials handling vehicle based primarily on data generated by the one or more vehicle sensors;
receiving, by the computing device via the vehicle transceiver, data from a subset of transceiver anchors of the plurality of transceiver anchors;
determining, by the computing device, a second dimension of the position of the materials handling vehicle primarily based on the received data via the vehicle transceiver; and
determining, by the computing device, the position of the materials handling vehicle from the first dimension and the second dimension.

19. The method of claim 18, further comprising providing a user option to manually alter a weighting of using the vehicle transceiver to determine the first dimension.

20. The method of claim 18, wherein the materials handling vehicle further includes at least one of the following: a wire guidance device for engaging wire guidance in an aisle or a floor guide rail system.
